(19) United States
(12) Patent Application Publication
(10) Pub. No.: US 2015/0224971 A1
(43) Pub. Date: Aug. 13, 2015

(54) CONTROL APPARATUS FOR VEHICULAR DRIVE SYSTEM

(71) Applicants: Takahiro Yoshimura, Toyota-shi (JP); Hideki Tamoto, Toyota-shi (JP); Masayuki Hashimoto, Toyota-shi (JP); Minoru Onitake, Kariya-shi (JP); Shun Ohno, Anjo-shi (JP)

(72) Inventors: Takahiro Yoshimura, Toyota-shi (JP); Hideki Tamoto, Toyota-shi (JP); Masayuki Hashimoto, Toyota-shi (JP); Minoru Onitake, Kariya-shi (JP); Shun Ohno, Anjo-shi (JP)

(73) Assignee: TOYOTA JIDOSHA KABUSHIKI KAISHA, Toyota-shi, Aichi (JP)

(21) Appl. No.: 14/422,199

(22) PCT Filed: Aug. 29, 2013
(86) PCT No.: PCT/JP2013/005130

§ 371 Date: Feb. 18, 2015

(30) Foreign Application Priority Data
Aug. 29, 2012 (JP) 2012-189202

(51) Int. Cl. B60T 8/1755; B60K 17/35

(52) U.S. Cl. CPC B60T 8/17555; B60K 17/35; B60T 8/17551

(57) ABSTRACT

A control apparatus for a vehicular drive system includes a pair of drive shafts, a differential gear device for distributing a received drive torque to left and right drive wheels through the respective drive shafts, a control clutch associated with one of the drive shafts and configured to switch between its engaged and released states, and a braking device disposed to apply a braking force to one of the drive wheels which is disposed to the other of the drive shafts. The control apparatus includes: a torque control portion configured to operate the braking device for reducing the torque to be transmitted to the one of the drive wheels, in the event of an abrupt increase of the torque received by the differential gear device while the control clutch is placed in the engaged state.

### TECHNICAL FIELD

The present invention relates to a control apparatus for a vehicular drive system, and more particularly to techniques for ensuring a high degree of stability of straight running of a vehicle.

### BACKGROUND ART

There is known a vehicular drive system which includes a drive power source in the form of an engine 100, a front wheel drive device in the form of a front differential gear device 104 for driving a pair of left and right front wheels 102l and 102r with a drive torque generated by the engine 100, a rear wheel drive device in the form of a rear differential gear device 110 for driving a pair of left and right rear wheels 108l and 108r through a pair of drive shafts 106l and 106r with the drive torque generated by the engine 100, and a control clutch 112 associated with the left drive shaft 106l and operable between its engaged and released states, as shown in FIG. 9 by way of example. This vehicular drive system is placed in a 4-wheel-drive mode (4WD mode) when the control clutch 112 is placed in the engaged state. Patent Documents 1 and 2 disclose examples of such a vehicular drive system.

### CITATION LIST

### Patent Literature

PTL 1: JP-2011-255846 A

PTL 2: JP-2010-260383 A

### SUMMARY OF INVENTION

### Technical Problem

In the vehicular drive system constructed as described above, a slipping action of at least one of the left and right front wheels 102l, 102r on a low-.mu. roadway surface 114 (having a low friction coefficient) during straight running of a vehicle in the 4WD mode may cause an abrupt increase of the drive torque transmitted from the engine 100 to the rear wheels 108l, 108r, and a consequent slipping action of the control clutch 112 which has been held in the engaged state. In this case, a rotating speed of the left drive shaft 106l associated with the control clutch 112, namely, a rotating speed W_{CL} of a side gear 110l of the rear differential gear device 110 which is connected to the left drive shaft 106l becomes higher than a rotating speed of the other or right drive shaft 106r not associated with the control clutch 112, namely, a rotating speed W_{AR} of a side gear 110r of the rear differential gear device 110 connected to the right drive shaft 106r, by a slipping speed .Delta.W of the control clutch 112, as indicated in FIG. 10, so that a torque transmitted to the right rear wheel 108r connected to the side gear 110r being rotated at the lower speed W_{DR} becomes larger than a torque transmitted to the left rear wheel 108l, due to a friction resistance of the side gears 110l, 110r serving as differential gears of the rear differential gear device 110, giving rise to a risk of a counterclockwise rotary motion of a steering wheel of the vehicle unexpected by the vehicle operator, as indicated in FIG. 9 by way of example, giving an adverse influence on the stability of straight running of the vehicle. A similar risk may take place in a 2-wheel-drive vehicle not provided with the front differential gear device 104 shown in FIG. 9. In FIG. 10, W_{TL} represents a rotating speed of the left rear wheel 108l while W_{TR} represents a rotating speed of the right rear wheel 108r, and W_{DL} and W_{DR} also respectively represent rotating speeds of the left and right drive shafts 106l and 106r respectively connected to the side gears 110l and 110r.

The present invention was made in view of the background art described above. It is therefore an object of the present invention to provide a control apparatus for a vehicular drive system, which ensures a high degree of stability of straight running of a vehicle even in the event of a slipping action of the above-described control clutch due to an abrupt increase of the drive torque transmitted to drive wheels of the vehicle.

### Solution to Problem

The object indicated above is achieved according to a first aspect of the present invention, which provides a control apparatus for (a) a vehicular drive system including a pair of drive shafts, a differential gear device for distributing a received drive torque to left and right drive wheels through said respective drive shafts, a control clutch associated with one of the above-described drive shafts and configured to switch between its engaged and released states, and a braking device disposed to apply a braking force to one of the above-described drive wheels which is disposed to the other of the above-described drive shafts, (b) the control apparatus comprising a torque control portion configured to operate the above-described braking device for reducing the torque to be transmitted to the above-described one of the drive wheels, in the event of an abrupt increase of the torque received by the above-described differential gear device while the above-described control clutch is placed in the engaged state.

### ADVANTAGEOUS EFFECTS OF INVENTION

The control apparatus constructed according to the first aspect of the present invention comprises the torque control portion which is configured to operate the above-described braking device for reducing the torque to be transmitted to the above-described one of the drive wheels, in the event of an abrupt increase of the torque received by the above-described differential gear device while the above-described control clutch is placed in the engaged state. The operation of the braking device to reduce the torque to be transmitted to the above-described one drive wheel ensures a high degree of stability of straight running of the vehicle, even in the event of a slipping action of the control clutch due to the abrupt increase of the drive torque received by the differential gear device, which slipping action would cause the torque of the above-indicated one drive wheel to be larger than the torque of the other drive wheel disposed on the side of the control clutch. Accordingly, the torque control portion reduces or prevents a risk of an unexpected counterclockwise or clockwise rotary motion of a steering wheel of the vehicle during the straight running of the vehicle.

In a first preferred form of the first aspect of the present invention, the control apparatus further comprises a braking force calculating portion configured to calculate a braking force which is generated by the above-described braking device and applied to the above-described one of the left and right drive wheels, such that the braking force reduces a difference between the torques to be transmitted to the left and right drive wheels. In this preferred form of the invention, the above-described torque control portion controls the braking device such that the calculated braking force is applied to the above-described one of the drive wheels. Accordingly, the operation of the braking device to apply the calculated braking force to the above-described one drive wheel reduces the difference between the torques to be transmitted to the left and right drive wheels, making it possible to effectively reduce or prevent the risk of the unexpected counterclockwise or clockwise rotary motion of the steering wheel during the straight running of the vehicle.

In a second preferred form of the first aspect of the invention, the above-described torque control portion operates said braking device to output a braking torque on the basis of a control clutch transmitted torque which is transmitted through the above-described control clutch, and according to a predetermined relationship between the braking force and the control clutch transmitted torque. The reduction of the torque to be transmitted to the above-described one drive wheel by application of the calculated braking force by the braking device effectively reduces the difference between the torques to be transmitted to the left and right drive wheels.

The object indicated above is also achieved according to a second aspect of this invention, which provides a control apparatus for (a) a 4-wheel-drive vehicular drive system including a vehicular drive system according to the above-described first aspect of the invention as a rear wheel drive device for driving the above-described left and right drive wheels provided as left and right rear wheels, with a drive torque generated by a drive power source, and a front wheel drive device for driving left and right front wheels with the drive torque generated by the above-described drive power source, the 4-wheel-drive vehicular drive system being placed in a 4-wheel-drive mode when the above-described control clutch provided in the above-described rear wheel drive device is placed in the engaged state, (b) the control apparatus comprising a torque control portion configured to operate the above-described braking device for reducing the torque to be transmitted to one of the above-described left and right rear wheels which corresponds to the above-described one of the left and right drive wheels, in the event of a slipping action of at least one of the left and right front wheels while the 4-wheel-drive vehicular drive system is placed in the above-indicated 4-wheel-drive mode. The engaging operation of the braking device to reduce the torque to be transmitted to the above-described one rear wheel ensures a high degree of stability of straight running of the vehicle, even in the event of an occurrence of slipping in the control clutch during which abrupt increase of the drive torque received by the differential gear device takes place due to a slipping action of at least one of the left and right front wheels in the 4-wheel-drive mode and would cause the torque of the above-indicated one rear wheel to be larger than the torque of the other rear wheel disposed on the side of the control clutch. Accordingly, the torque control portion reduces or prevents a risk of an unexpected counterclockwise or clockwise rotary motion of a steering wheel of the vehicle during the straight running of the vehicle.

The object indicated above is also achieved according to a third aspect of this invention, which provides a control apparatus for (a) a 4-wheel-drive vehicular drive system including a vehicular drive system according to the above-described first aspect of the invention as a front wheel drive device for driving the above-described left and right drive wheels provided as left and right front wheels, with a drive torque generated by a drive power source, and a rear wheel drive device for driving left and right rear wheels with the drive torque generated by the above-described drive power source, the 4-wheel-drive vehicular drive system being placed in a 4-wheel-drive mode when the above-described control clutch provided in the above-described rear wheel drive device is placed in the engaged state, (b) the control apparatus comprising a torque control portion configured to operate the above-described braking device for reducing the torque to be transmitted to one of the above-described left and right front wheels which corresponds to the above-described one of the left and right drive wheels, in the event of a slipping action of at least one of the left and right rear wheels while the 4-wheel-drive vehicular drive system is placed in the 4-wheel-drive mode. The engaging operation of the braking device to reduce the torque to be transmitted to the above-described one front wheel ensures a high degree of stability of straight running of the vehicle, even in the event of an occurrence of slipping in the control clutch during which abrupt increase of the drive torque received by the differential gear device takes place due to a slipping action of at least one of the left and right rear wheels in the 4-wheel-drive mode and would cause the torque of the above-indicated one front wheel to be larger than the torque of the other front wheel disposed on the side of the control clutch. Accordingly, the torque control portion reduces or prevents a risk of an unexpected counterclockwise or clockwise rotary motion of a steering wheel of the vehicle during the straight running of the vehicle.

### BRIEF DESCRIPTION OF DRAWINGS

FIG. 1 is a schematic view showing a drive system of an FF 4-wheel-drive vehicle, which is controlled by a control apparatus according to the present invention;

FIG. 2 is a functional block diagram showing major control functions of an electronic control device provided as one embodiment of the control apparatus of the invention for controlling the drive system of FIG. 1;

FIG. 3 is a view showing an example of a map used by a braking force calculating portion of the electronic control device of FIG. 2, to calculate a braking force on the basis of a control clutch transmitted torque calculated in a control clutch transmitted torque calculating portion;

FIG. 4 is a flow chart illustrating a control operation performed by the electronic control device of FIG. 2 to ensure a high degree of stability of straight running of the vehicle in a 4WD mode;

FIG. 5 is a view showing the vehicular drive system of FIG. 1 when the control clutch is placed in a slipping state due to an abrupt increase of a drive torque transmitted from an engine to rear wheels, which abrupt increase takes place as a result of a slipping action of at least one of left and right front wheels on a low-.mu. roadway surface during the straight running of the vehicle in the 4WD mode;

FIG. 6 is a functional block diagram showing major control functions of an electronic control device provided as another embodiment of the control apparatus of this invention for controlling a vehicular drive system;

FIG. 7 is a flow chart illustrating a control operation performed by the electronic control device of FIG. 6 to ensure a high degree of stability of straight running of the vehicle in the 4WD mode;

FIG. 8 is a schematic view showing another vehicular drive system according to a further embodiment of the invention, which is controlled by the control apparatus of the present invention;

FIG. 9 is a schematic view showing a prior art vehicular drive system when a control clutch is placed in a slipping state due to an abrupt increase of the drive torque transmitted from the engine to the rear wheels, which abrupt increase takes place as a result of a slipping action of at least one of the left and right front wheels on a low-.mu. roadway surface during the straight running of the vehicle in the 4WD mode; and

FIG. 10 is a view indicating the rotating speeds of the left and right rear wheels and the rotating speeds of the drive shafts respectively connected to the rear wheels, when the control clutch provided in the vehicular drive system of FIG. 9 is placed in a slipping state.

### DESCRIPTION OF EMBODIMENTS

The preferred embodiments of this invention will be described in detail by reference to the drawings. It is to be understood that the drawings do not necessarily accurately show the dimensions and other properties of various elements of the illustrated embodiments.

### EXAMPLE 1

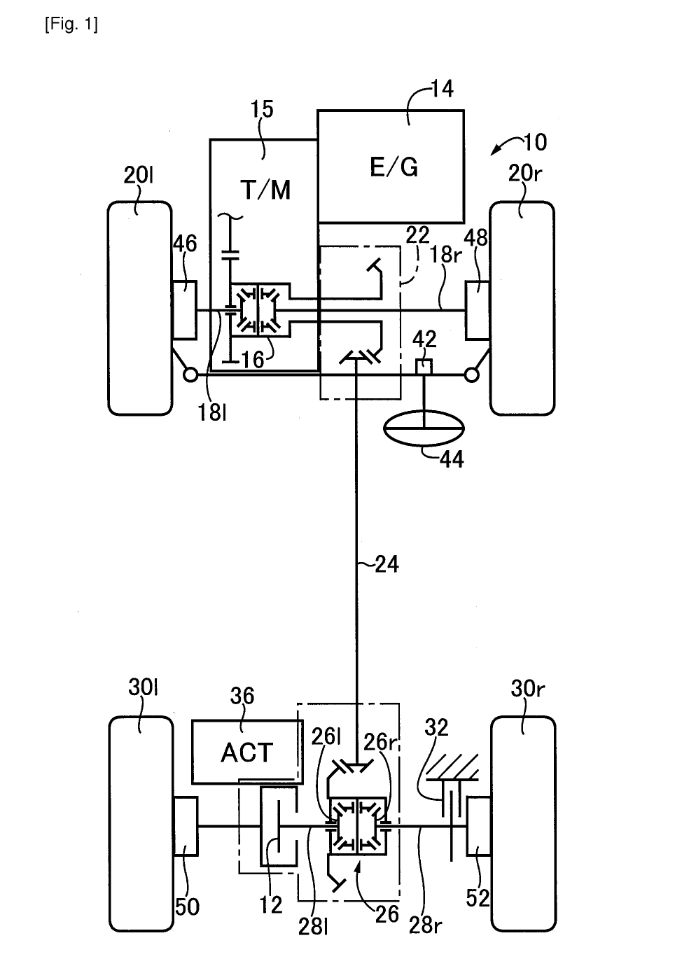

Referring first to the schematic view of FIG. 1, there is shown a vehicular drive system 10, which is a 4-wheel-drive vehicular drive system constructed so as to be principally operated as an FF (front-engine front-drive) type drive system which is selectively placed in a 2-wheel-drive mode or a 4-wheel-drive mode by controlling a control clutch 12. In this vehicular drive system 10, a drive torque generated by a drive power source in the form of an engine 14 is transmitted to a pair of left and right front wheels 20l and 20r (hereinafter referred to simply as “front wheels 20”, unless otherwise specified) via an automatic transmission 15, a front wheel drive device in the form of a front differential gear device 16 and a pair of left and right front axles 18l and 18r, and to a pair of left and right rear wheels (drive wheels) 30l and 30r (hereinafter referred to simply as “rear wheels 30”, unless otherwise specified) via the automatic transmission 15, a transfer 22, a propeller shaft 24, a rear wheel drive device in the form of a rear differential gear device 26 and a pair of left and right rear axles (drive shafts) 28l and 28r. The front differential gear device 16 is configured to distribute the received drive torque to the left and right front wheels 20l and 20r via the left and right front axles 18l and 18r, for driving the front wheels 20, while the rear differential gear device 26 is configured to distribute the received drive torque to the left and right rear wheels 30l and 30r via the left and right rear axles 28l and 28r, for driving the rear wheels 30. The rear differential gear device 26 is a limited slip differential (LSD) device which is provided with a pair of side gears 26l and 26r accommodated within a differential casing and wherein the torque is automatically transmitted from one of the side gears 26l, 26r which is rotated at a higher speed, to the other side gear 26l, 26r, in the presence of coned-disc springs that bias the side gears 26l, 26r against the differential casing in the axial direction, for thereby positively generating a rotary friction resistance of the side gears 26 with respect to the differential casing. One of the rear axles 28l, 28r, namely, the left rear axle 28l is provided with the above-indicated control clutch 12 which is configured to selectively connect or disconnect the rear differential gear device 26 to or from the left rear wheel 30l.

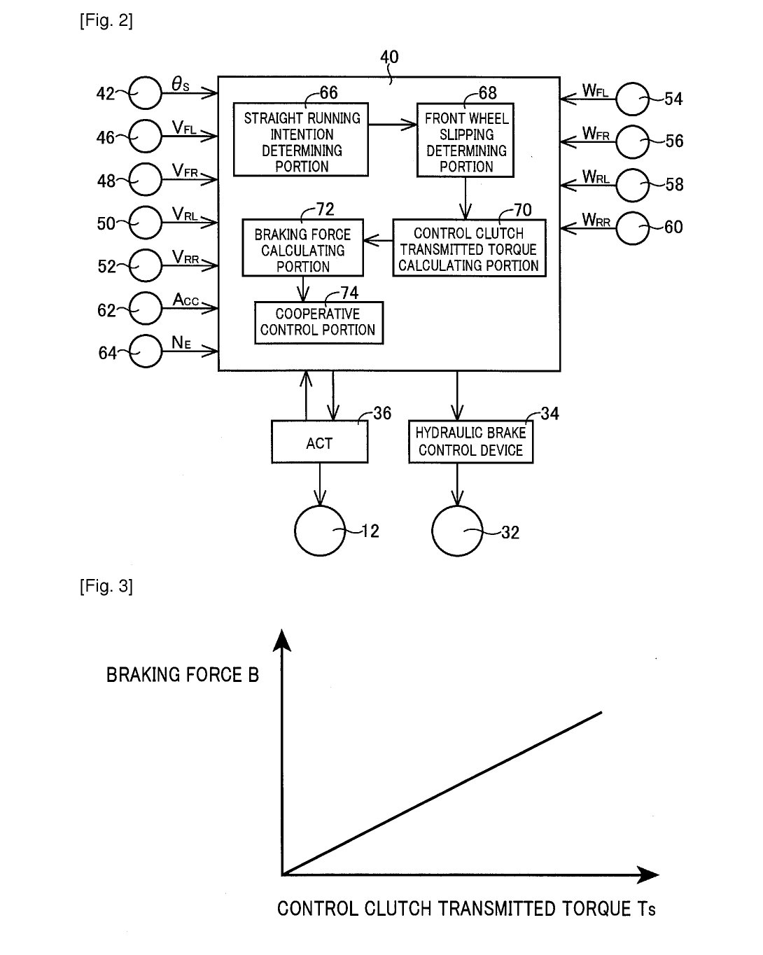

The front wheels 20 and the rear wheels 30 are provided with respective hydraulic braking devices (wheel braking devices) 32 having hydraulic cylinders to mechanically generate braking forces (braking torques) B for braking those wheels 20, 30. In FIG. 1, only the hydraulic braking device 32 for the right rear wheel 30r is shown, and the hydraulic braking devices 32 for the front wheels 20l and 20r and the left rear wheel 30l are not shown. The braking forces generated by the hydraulic braking devices 32 are controlled by a hydraulic brake control device 34 (shown in FIG. 2), which is provided with electromagnetic hydraulic control valves and switching valves, which are controlled according to brake control signals received from a control apparatus in the form of an electronic control device 40 (also shown in FIG. 2), to regulate the braking forces B to be generated by the hydraulic braking devices 32 and applied to the front wheels 20 and the rear wheels 30. In FIG. 1, hydraulic braking devices 32 disposed with front wheels 20l, 20r and rear wheel 30l are omitted.

As shown in FIG. 1, the control clutch 12 is provided with an actuator 36 having a piston (not shown) movable to place the control clutch 12 in its engaged state. When the control clutch 12 is brought into in the engaged state by the actuator 36, the vehicular drive system 10 is placed in the 4-wheel-drive mode in which the drive torque generated by the engine 14 is transmitted to both the front wheels 20 and the rear wheels 30. When the control clutch 12 is brought into its released state by the actuator 36, the vehicular drive system 10 is placed in the 2-wheel-drive mode in which the drive torque generated by the engine 14 is transmitted to only the front wheels 20. With regard to the rear differential gear device 26 in the 2-wheel-drive mode established when the control clutch 12 is placed in the released state, the drive torque is transmitted to neither the left rear wheel 30l nor the right rear wheel 30r, since the side gear 26l on the side of the control clutch 12 is freely rotated. A proportion (%) of the drive torques distributed to the front wheels 20 and the rear wheels 30 when the control clutch 12 is placed in the released state is 100% (front wheels 20): 0% (rear wheels 30), while the proportion when the control clutch 12 is placed in the fully engaged state is 50% (front wheels 20): 50% (rear wheels 30). The drive torque distribution percentage of the rear wheels 30 is continuously variable within a range between 0% and 50%, according to the degree of engagement (engaging force) of the control clutch 12. This control clutch 12, which is of a well-known type, may be a so-called “electronically controlled coupling”, for instance.

Referring next to the functional block diagram of FIG. 2, there are shown major control functions of the electronic control device 40. This electronic control device 40 includes a so-called microcomputer incorporating a CPU, a RAM, a ROM and an input-output interface. The CPU performs signal processing operations according to control programs stored in the ROM, while utilizing a temporary data storage function of the RAM. The electronic control device 40 is configured to receive: an output signal of a steering angle detecting device 42 indicative of a steering angle .theta.ₛ of a steering wheel 44; output signals of wheel speed sensors 46, 48, 50 and 52 respectively indicative of rotating speeds V_{FL}, V_{FR}, V_{RL} and V_{RR} of the left front wheel 20l, right front wheel 20r, left rear wheel 30l and right rear wheel 30r; output signals of load sensors 54, 56, 58 and 60 respectively indicative of loads W_{FL}, W_{FR}, W_{RL} and W_{RR} respectively acting on the left front wheel 20l, right front wheel 20r, left rear wheel 30l and right rear wheel 30r; an output signal of an accelerator pedal operation amount sensor 62 indicative of an operation amount A_{CC} of an accelerator pedal (not shown), which represents a vehicle output required by the vehicle operator; an output signal of an engine speed sensor 64 indicative of an operating speed N_{E} of the engine 14; and an output signal of the actuator 36 indicative of the operating state (degree of engagement or engaging force) of the control clutch 12.

As also shown in FIG. 2, the electronic control device 40 includes a straight running intention determining portion 66, a front wheel slipping determining portion 68, a control clutch transmitted torque calculating portion 70, a braking force calculating portion 72, and a cooperative control portion 74. The straight running intention determining portion 66 is configured to determine whether the vehicle operator has an intention of running the vehicle straight in the 4-wheel-drive mode established in the engaged state of the control clutch 12 by the actuator 36. This determination is made on the basis of the steering angle .theta.ₛ of the steering wheel 44 detected by the steering angle detecting device 42. For example, the straight running intention determining portion 66 determines that the vehicle operator has the intention of running the vehicle straight, if the steering angle .theta.ₛ of the steering wheel 44 detected by the steering angle detecting device 42 in the 4-wheel-drive mode is held within a predetermined range obtained by experimentation, for instance. If the steering angle .theta.ₛ of the steering wheel 44 is outside the predetermined range, the straight running intention determining portion 66 determines that the vehicle operator does not have the intention of running the vehicle straight, namely, the vehicle operator has an intention of turning the vehicle.

The front wheel slipping determining portion 68 is operated when the straight running intention determining portion 66 has determined that the vehicle operator has the intention of running the vehicle straight. The front wheel slipping determining portion 68 is configured to determine whether the front wheels 20 are placed in a slipping state. This determination is made on the basis of the wheel rotating speeds V_{FL}, V_{FR}, V_{RL} and V_{RR} detected by the respective wheel speed sensors 46, 48, 50 and 52. For example, the front wheel slipping determining portion 68 determines that the front wheels 20 are not placed in the slipping state, if a slip ratio Rs(%) of the front wheels 20 calculated on the basis of the wheel rotating speeds V_{FL}, V_{FR}, V_{RL} and V_{RR} detected by the respective wheel speed sensors 46, 48, 50, 52 is lower than a predetermined upper limit Rc(%) obtained by experimentation, and determines that the front wheels 20 are placed in the slipping state, if the calculated slip ratio Rs(%) is equal to or higher than the upper limit Rc(%). The slip ratio Rs(%) is calculated according to the following Equation (1), wherein VF=(V_{FL}+V_{FR})/2, and VR=(V_{RL}+V_{RR})/2. When the slip ratio Rs(%) becomes equal to or higher than the upper limit Rc(%) as a result of slipping of at least one of the left and right front wheels 20l and 20r in the 4-wheel-drive mode, the drive torque distributed to the front wheels 20 is transmitted to the rear wheels 30, so that the drive torque driving the rear wheels 30 abruptly increases, and may cause the control clutch 12 to be placed in a slipping state.

Rs(%)=(VF−VR)/VF×100 (1)

The control clutch transmitted torque calculating portion 70 is configured to calculate a control clutch transmitted torque (engaging torque capacity) Ts, which is the drive torque transmitted to the rear wheels 30 through the control clutch 12. This calculation is implemented on the basis of the output signals of the load sensors 54, 56, 58, 60, accelerator pedal operation amount sensor 62 and engine speed sensor 64. Described more specifically, the control clutch transmitted torque calculating portion 70 calculates a drive torque T_{E} generated by the engine 14 on the basis of the accelerator pedal operation amount A_{CC} detected by the accelerator pedal operation amount sensor 62 and the engine speed N_{E} detected by the engine speed sensor 64, and calculates the drive force distribution percentages (%) of the front wheels 20 and the rear wheels 30 on the basis of the loads acting on the front and rear wheels 20, 30 and detected by the load sensors 54, 56, 58, 60. The control clutch transmitted torque calculating portion 70 calculates the control clutch transmitted torque Ts on the basis of the calculated drive torque T_{E} and drive force distribution percentages (%) of the front and rear wheels 20, 30, such that the calculated control clutch transmitted torque Ts permits the drive force distribution proportion (%) of the front and rear wheels 20, 30 corresponding to the proportion of the loads acting on the front and rear wheels 20, 30. It is noted that the load acting on the front wheels 20 is an average of the loads W_{FL} and W_{FR} respectively acting on the left and right front wheels 20l, 20r, while the load acting on the rear wheels 30 is an average of the loads W_{RL} and W_{RR} respectively acting on the left and right rear wheels 30l, 30r.

After calculation of the control clutch transmitted torque Ts, the control clutch transmitted torque calculating portion 70 commands the actuator 36 to control the degree of engagement or engaging force of the control clutch 12 according to the calculated control clutch transmitted torque Ts. That is, a drive force distributing control in which predetermined drive torques are transmitted to the front and rear wheels 20, 30, to permit the drive force distribution proportion (%) of the front and rear wheels 20, 30 which is proportional to the proportion of the loads acting on the front and rear wheels 20, 30 in the 4-wheel-drive mode.

The braking force calculating portion 72 is operated when the control clutch transmitted torque calculating portion 70 has calculated the control clutch transmitted torque Ts after the determination by the straight running intention determining portion 66 that the vehicle operator has the intention of running the vehicle straight, and the determination by the front wheel slipping determining portion 68 that the front wheels 20 are placed in the slipping state. The braking force calculating portion 72 is configured to calculate a braking force B generated by the hydraulic braking device 32 provided for the right rear wheel 30r disposed on the side remote from the control clutch 12, on the basis of the calculated control clutch transmitted torque Ts and according to a predetermined relationship obtained by experimentation to maintain a high degree of stability of straight running of the vehicle. Described more specifically, after the calculation of the control clutch transmitted torque Ts by the control clutch transmitted torque calculating portion 70 as a result of the above-indicated determinations by the straight running intention determining portion 66 and the front wheel slipping determining portion 68, the braking force calculating portion 72 is operated to calculate the braking force B generated by the hydraulic braking device 32 for the right rear wheel 30r, on the basis of the calculated control clutch transmitted torque Ts and according to a map stored in the ROM and shown in FIG. 3 by way of example. This map, which is predetermined in view of LSD (limited slip differential) characteristics of the rear differential gear device 26, represents a relationship between the control clutch transmitted torque Ts and the braking force B. When the calculated braking force B is applied to the right rear wheel 30r, this braking force B reduces the drive torque to be transmitted from the side gear 26l rotating at a higher speed to the side gear 26r rotating at a lower speed, due to a friction resistance of the side gears 26l, 26r within the rear differential gear device 26 as a result of the slipping action of the control clutch 12, which takes place due to an abrupt increase of the drive torque of the rear wheels 30 beyond the engaging torque capacity Ts of the control clutch 12, in the event of slipping of the front wheels 20 with the slip ratio Rs being equal to or higher than the upper limit Rc. Accordingly, the braking force B reduces a difference between the drive torques transmitted to the left and right rear wheels 30l, 30r.

After the calculation of the control clutch transmitted torque Ts by the control clutch transmitted torque calculating portion 70 and the calculation of the braking force B by the braking force calculating portion 72, the cooperative control portion 74 commands the actuator 36 to control the degree of engagement or engaging force of the control clutch 12 so as to establish the calculated control clutch transmitted torque Ts, and commands the hydraulic brake control device 34 to control the hydraulic braking device 32 for the right rear wheel 30r so as to reduce the difference between the drive torques of the left and right rear wheels 30, which difference has increased as a result of the slipping action of the front wheels 20 during the straight running of the vehicle.

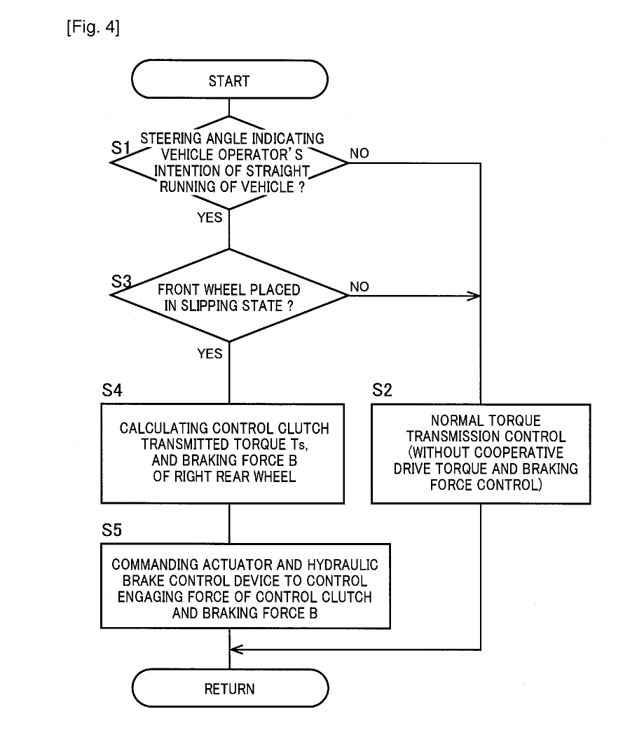

Referring further to the flow chart of FIG. 4, major part of the control operation performed by the electronic control device 40 of FIG. 2 will be described. This control operation is repeatedly performed with a predetermined cycle time.

The control operation illustrated in FIG. 4 is initiated with step S1 (hereinafter “step” being omitted) corresponding to the straight running intention determining portion 66. S1 is implemented to determine whether the vehicle operator has the intention of running the vehicle straight, that is, whether the vehicle is running straight. If a negative determination is obtained in S1, that is, if the vehicle operator has the intention of turning the vehicle, the control flow goes to S2 corresponding to the control clutch transmitted torque calculating portion 70. If an affirmative determination is obtained in S1, the control flow goes to S3 corresponding to the front wheel slipping determining portion 68. S2 is implemented to perform a torque transmission control (normal torque transmission control) to transmit the predetermined drive torques to the front wheels 20 and the rear wheels 30 such that the drive force distribution proportion (%) of the front and rear wheels 20, 30 is proportional to the proportion of the loads acting on the front and rear wheels 20, 30. Namely, S2 is implemented to perform the above-indicated normal torque transmission control, rather than a cooperative drive force and braking force control to be implemented in S5 by the cooperative control portion 74 for controlling the drive torques and the braking force B to be generated by the hydraulic braking device 32.

S3 corresponding to the front wheel slipping determining portion 68 is implemented to determine whether the front wheels 20 are placed in the slipping state with the slip ratio Rs being equal to or higher than the upper limit Rc. If a negative determination is obtained in S3, that is, if the front wheels 20 are not placed in the slipping state with the slip ratio Rs being lower than the upper limit Rc, the control flow goes to the above-described S2. If an affirmative determination is obtained in S3, the control flow goes to S4 corresponding to the control clutch transmitted torque calculating portion 70 and the braking force calculating portion 72. S4 is implemented to calculate the control clutch transmitted torque Ts and calculate the braking force B on the basis of the calculated control clutch transmitted torque Ts.

After the control clutch transmitted torque Ts and the braking force B are calculated in S4, the control flow goes to S5 corresponding to the cooperative control portion 74, to command the actuator 36 to control the engaging force of the control clutch 12 on the basis of the calculated control clutch transmitted torque Ts, and to command the hydraulic brake control device 34 to control the hydraulic braking device 32 provided for the right rear wheel 30r, on the basis of the calculated braking force B. A part of the cooperative control portion 74 assigned to command the hydraulic brake control device 34 functions as a torque control portion configured to operate the hydraulic braking device 32 for the right rear wheel 30r, for reducing the torque to be transmitted to the right rear wheel 30r.

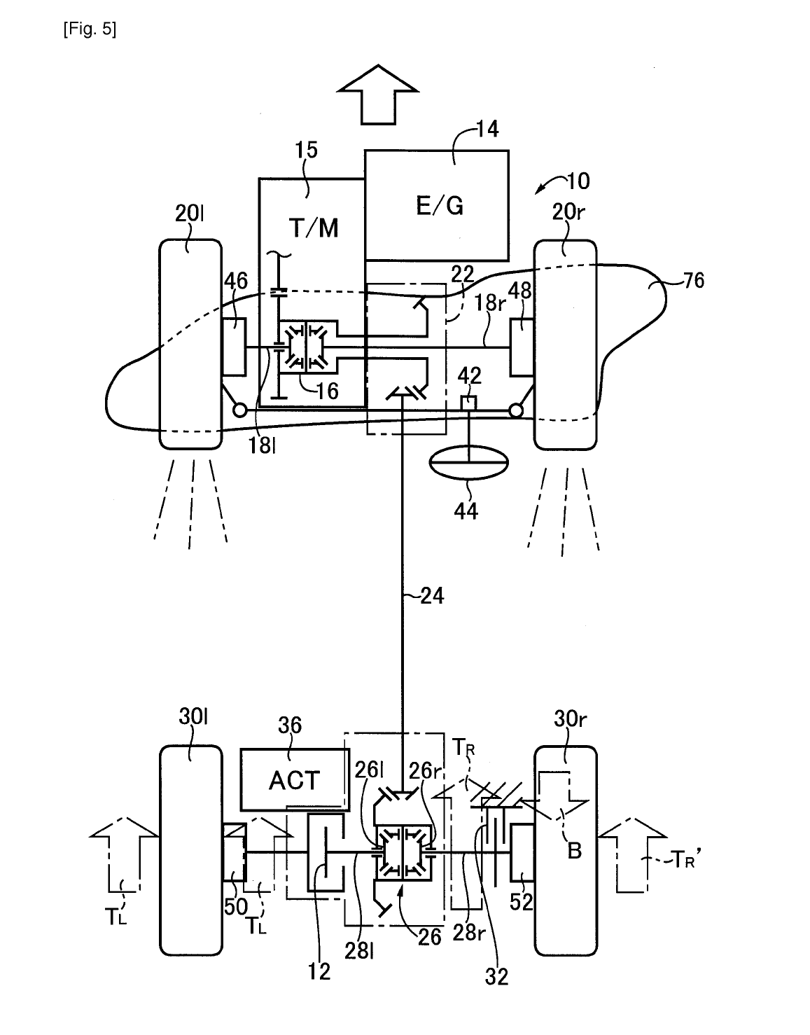

Reference is now made to FIG. 5 showing the vehicular drive system 10 when the control clutch 12 is placed in the slipping state due to an abrupt increase of the drive torque transmitted from the engine 14 to the rear wheels 30, which abrupt increase takes place as a result of the slipping action of at least one of the left and right front wheels 20 on a low-.mu. roadway surface 76 during the straight running of the vehicle in the 4WD mode (4-wheel-drive mode). As a result of the slipping action of the control clutch 12, the rotating speed of the side gear 26l on the side of the control clutch 12 becomes higher than the rotating speed of the side gear 26r on the side remote from the control clutch 12 so that the torque T_{R} transmitted to the right rear wheel 30r connected to the side gear 26r being rotated at the lower speed becomes larger than the torque T_{L} transmitted to the left rear wheel 30l, due to a friction resistance of the side gears 26l, 26r disposed within the rear differential gear device 26, as indicated in FIG. 5. However, the braking force B applied to the right rear wheel 30r by the hydraulic braking device 32 reduces the torque T_{R} to be transmitted to the right rear wheel 30r. In FIG. 5, the thus reduced torque value T_{R} is represented by T_{R}′. Accordingly, the difference between the torques transmitted to the left and right rear wheels 30l, 30r, that is, the difference between the torques T_{L} and T_{R}^{'} is adequately reduced.

As described above, the electronic control device 40 provided according to the present embodiment of the invention to control the vehicular drive system 10 comprises the cooperative control portion 74 serving as the torque control portion configured to operate the hydraulic braking device 32 for reducing the torque T_{R} to be transmitted to the right rear wheel 30r, in the event of an abrupt increase of the torque transmitted from the engine 14 to the rear wheels 30 through the rear differential gear device 26 during straight running of the vehicle in the 4WD mode with the control clutch 12 being placed in the engaged state. The operation of the hydraulic braking device 32 to reduce the torque T_{R} to be transmitted to the right rear wheel 30r ensures a high degree of stability of straight running of the vehicle, even in the event of a slipping action of the control clutch 12 due to the abrupt increase of the drive torque transmitted from the engine 14 to the rear wheels 30, which slipping action would cause the torque T_{R} of the right rear wheel 30r to be larger than the torque T_{L} of the left rear wheel 30l disposed on the side of the control clutch 12. Accordingly, the cooperative control portion 74 reduces or prevents a risk of an unexpected counter-clockwise or clockwise rotary motion of the steering wheel 44 during the straight running of the vehicle.

The electronic control device 40 provided for the vehicular drive system 10 further comprises the braking force calculating portion 72 configured to calculate the braking force B which is generated by the hydraulic braking device 32 and applied to the right rear wheel 30r, such that the braking force B reduces a difference between the torques T_{L} and T_{R}′ to be transmitted to the left and right rear wheels 30l and 30r. The cooperative control portion 74 serving as the torque control portion controls the hydraulic braking device 32 such that the calculated braking force B is applied to the right rear wheel 30r. Accordingly, the operation of the hydraulic braking device 32 to apply the calculated braking force B to the right rear wheel 30r reduces the difference between the torques T_{L} and T_{R}′ to be transmitted to the left and right rear wheels 30l and 30r, making it possible to effectively reduce or prevent the risk of the unexpected counter-clockwise or clockwise rotary motion of the steering wheel 44 during the straight running of the vehicle.

Further, the braking force calculating portion 72 is configured to calculate the braking force B to be generated by the hydraulic braking device 32, on the basis of the control clutch transmitted torque Ts calculated by the control clutch transmitted torque calculating portion 70, and according to the map formulated in view of the LSD (limited slip differential) characteristics of the rear differential gear device 26, which map represents a predetermined relationship between the braking force B and the control clutch transmitted torque Ts. The reduction of the torque T_{R} to be transmitted to the right rear wheel 30r by application of the calculated braking force B by the hydraulic braking device 32 effectively reduces the difference between the torques T_{L} and T_{R}′ to be transmitted to the left and right rear wheels 30l and 30r.

Further, the electronic control device 40 serves as a control apparatus for a 4-wheel-drive vehicular drive system including the rear differential gear device 26 driving the left and right rear wheels 30l and 30r with the drive torque generated by the engine 14, and the front differential gear device 16 for driving the left and right front wheels 20l and 20r with the drive torque generated by the engine 14, and the 4-wheel-drive vehicular drive system is placed in the 4-wheel-drive mode when the control clutch 12 is placed in the engaged state. The cooperative control portion 74 of the electronic control device 40 serves as the torque control portion configured to operate the hydraulic braking device 32 for reducing the torque T_{R} to be transmitted to the right rear wheel 30r, in the event of a slipping action of at least one of the left and right front wheels 20l and 20r while the 4-wheel-drive vehicular drive system is placed in the 4-wheel-drive mode. The operation of the hydraulic braking device 32 to reduce the torque T_{R} to be transmitted to the right rear wheel 30r ensures a high degree of stability of straight running of the vehicle, even in the event of a slipping action of the control clutch 12 due to an abrupt increase of the drive torque T_{R} received by the rear differential gear device 26, which abrupt increase takes place due to a slipping action of at least one of the left and right front wheels 20l and 20r and would cause the torque T_{R} of the right rear wheel 30r to be larger than the torque T_{L} of the left rear wheel 30l disposed on the side of the control clutch 12. Accordingly, the torque control portion reduces or prevents a risk of an unexpected counterclockwise or clockwise rotary motion of the steering wheel 44 of the 4-wheel-drive vehicle during the straight running of the vehicle.

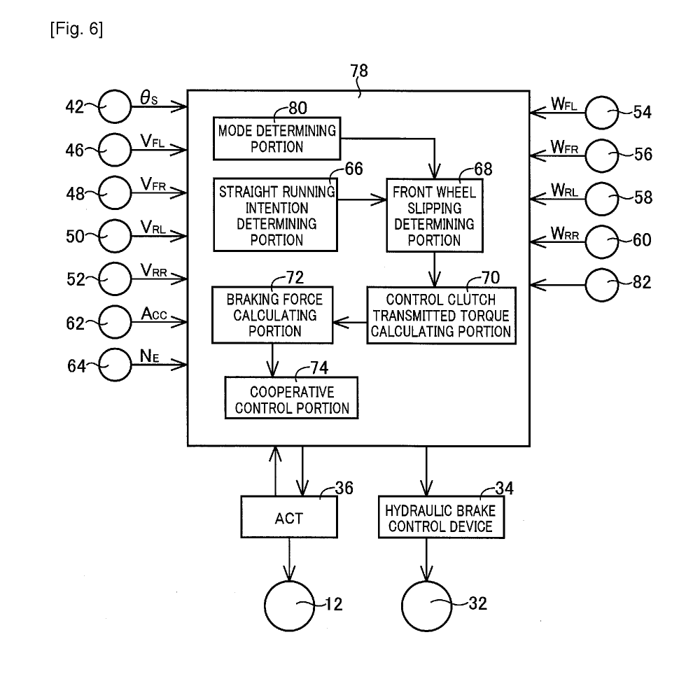

The other embodiments of this invention will be described in detail by reference to FIGS. 6-8. The same reference signs as used in the first embodiment will be used in the following embodiments, to identify the same elements, which will not be described redundantly.

### EXAMPLE 2

An electronic control device (control apparatus) 78 according to the second embodiment of this invention to control the vehicular drive system 10 is functionally different from the electronic control device 40 according to the first embodiment in that the electronic control device 78 further includes a mode determining portion 80, as shown in FIG. 6. The vehicular drive system 10 controlled by this electronic control device 78 is provided with a mode selector switch 82 (also shown in FIG. 6) used by the vehicle operator to select one of a high-drivability drive mode and a high-fuel-economy drive mode during running of the vehicle in the 4-wheel-drive mode. The electronic control device 78 is configured to receive an output signal of the mode selector switch 82 indicative of the operator's selected one of the high-drivability and high-fuel-economy drive modes.

On the basis of the output signal of the mode selector switch 82, the mode determining portion 80 determines one of the high-drivability and high-fuel-economy drive modes which is presently selected in the 4-wheel-drive mode. In the high-drivability drive mode, the cooperative control portion 74 is operated to implement the torque control operation to control the drive torques to be transmitted to the front wheels 20 and the rear wheels 30, such that the drive force distribution proportion (%) of the front and rear wheels 20, 30 is proportional to the proportion of the loads acting on the front and rear wheels 20, 30 in the 4-wheel-drive mode, and also to implement the braking force control to control the hydraulic braking device 32 to generate the braking force B for reducing the torque T_{R} to be transmitted to the right rear wheel 30r, to thereby ensure a high degree of stability of straight running of the vehicle in the 4WD drive mode. In the high-fuel-economy drive mode, the cooperative control portion 74 implements only the torque control operation, without implementing the braking force control, for ensuring a high degree of fuel economy of the vehicle.

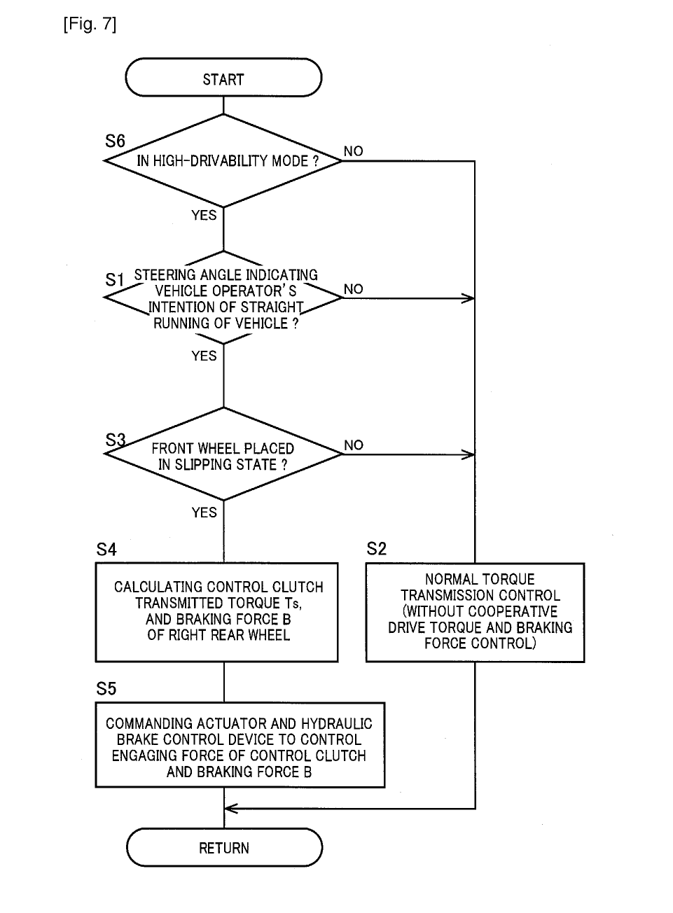

Referring to the flow chart of FIG. 7, major part of the control operation performed by the electronic control device 78 of FIG. 6 will be described. This control operation is repeatedly performed with a predetermined cycle time. Since steps S1-S5 in FIG. 7 are identical with steps S1-S5 in FIG. 4, the steps S1-S5 in FIG. 7 will not be described redundantly.

The control operation of FIG. 7 is initiated with S6 corresponding to the mode determining portion 80, to determine whether the high-drivability drive mode is presently selected. If a negative determination is obtained in S6, that is, if the high-fuel-economy drive mode is presently selected, the control flow goes to S2 corresponding to the control clutch transmitted torque calculating portion 70, so that the braking force control described above will not be implemented. If an affirmative determination is obtained in S6, the control flow goes to S1 corresponding to the straight running intention determining portion 66, so that the braking force control will be implemented in S5.

As described above, the electronic control device 78 provided according to the present second embodiment for controlling the vehicular drive system 10 receives the output signal of the mode selector switch 82 indicative of the presently selected one of the high-drivability drive mode in which the braking force control is implemented in the 4-wheel-drive mode, and the high-fuel-economy drive mode in which the braking force control is not implemented in the 4-wheel-drive mode. Thus, the braking force control to control the hydraulic braking device 32 for the right rear wheel 30r is implemented or not implemented according to the output signal of the mode selector switch 82 manually operated by the vehicle operator, so that the vehicle can be run according to the intention of the vehicle operator.

### EXAMPLE 3

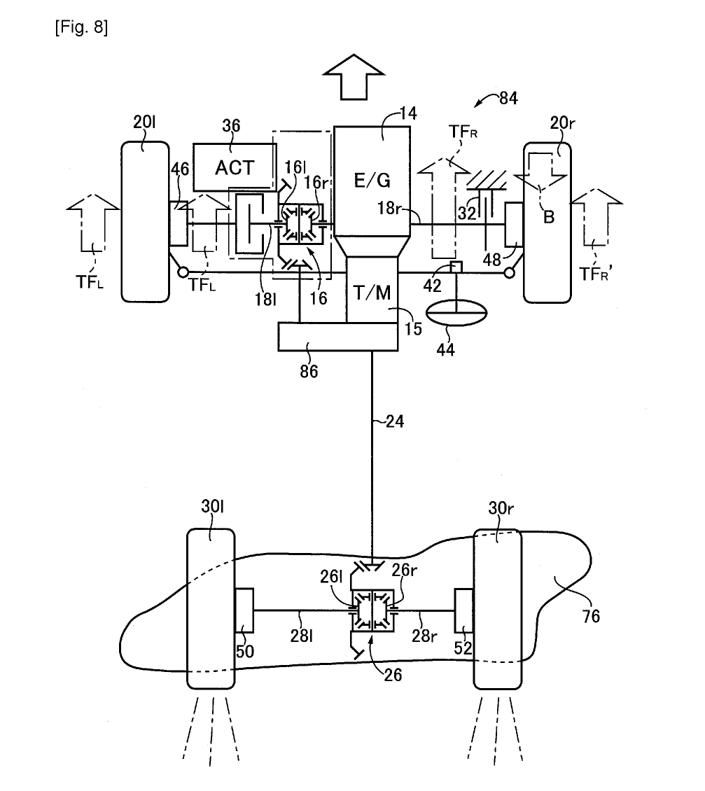

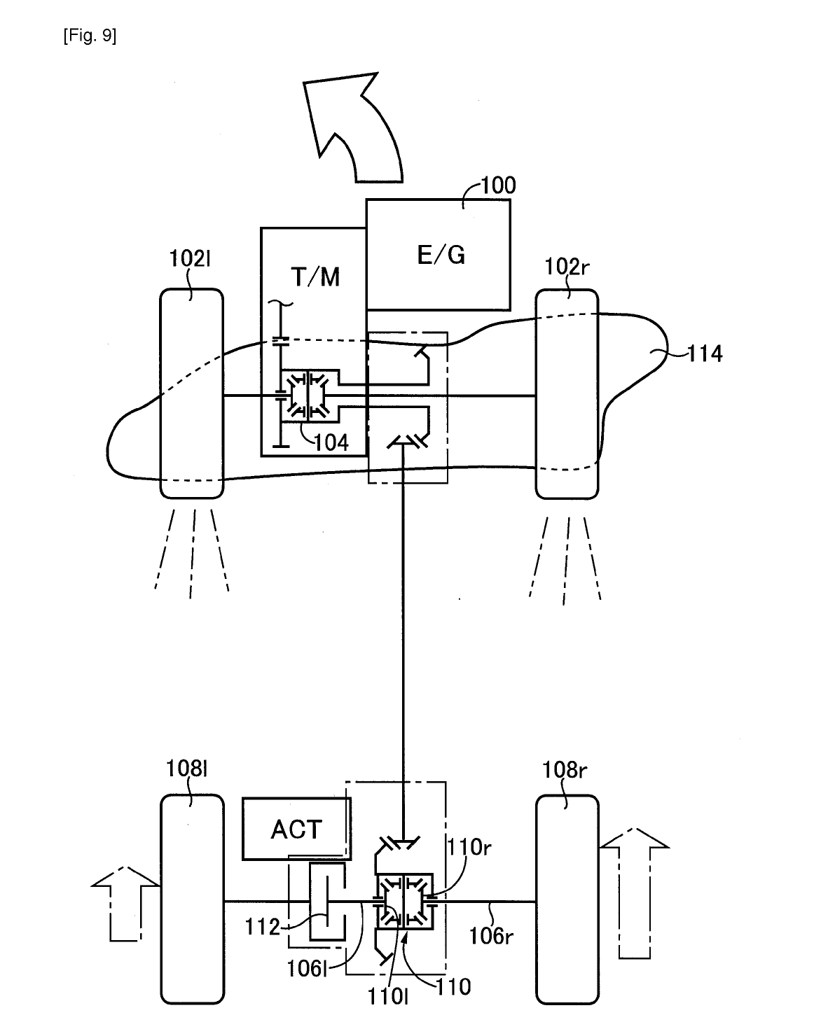

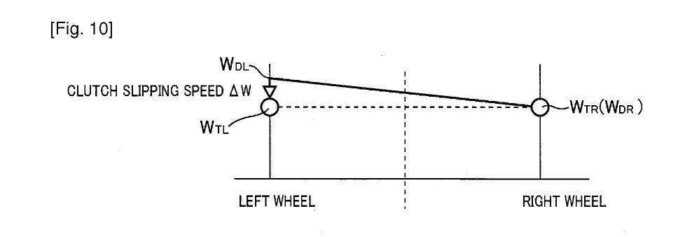

Referring to the schematic view of FIG. 8, there is shown another vehicular drive system 84 according to a further embodiment of the invention, which is controlled by the control apparatus of the present invention. As shown in FIG. 8, the vehicular drive system 84 is a 4-wheel-drive vehicular drive system constructed so as to be principally operated as an FR (front-engine rear-drive) type drive system which is selectively placed in a 2-wheel-drive mode or a 4-wheel-drive mode by controlling the control clutch 12. In this vehicular drive system 84, the drive torque generated by the engine 14 is transmitted to the left and right rear wheels 30l and 30r via the automatic transmission 15, a transfer 86, the propeller shaft 24, the rear differential gear device 26 and the left and right rear 28l and 28r, and to the left and right front wheels 20l and 20r via the automatic transmission 15, the transfer 86, the front differential gear device 16 and the left and right front axles 18l and 18r. The front differential gear device 16 is a limited slip differential (LSD) device which is provided with a pair of side gears 16l and 16r accommodated within a differential casing and wherein the torque is automatically transmitted from one of the side gears 16l, 16r which is rotated at a higher speed, to the other side gear 16l, 16r, in the presence of coned-disc springs that bias the side gears 16l, 16r against the differential casing in the axial direction, for thereby positively generating a rotary friction resistance of the side gears 16l, 16r with respect to the differential casing. One of the front axles 18l, 18r, namely, the left front axle 18l is provided with the above-indicated control clutch 12 which is configured to selectively connect or disconnect the front differential gear device 16 to or from the left front wheel 20l. In FIG. 8, only the hydraulic braking device 32 for the right front wheel 20r is shown, and the hydraulic braking devices 32 for the left front wheel 20l and the left and right rear wheels 30l and 30r are not shown.

The electronic control device (control apparatus) according to the present third embodiment for the vehicular drive system 84 is substantially identical with the electronic control device 40 according to the first embodiment for the vehicular drive system 10, except in that the front wheel slipping determining portion 68 provided in the first embodiment for determining whether the front wheels 20l, 20r are placed in a slipping state is replaced by a rear wheel slipping determining portion provided in the third embodiment for determining whether the rear wheels 30l, 30r are placed in a slipping state.

The control clutch 12 provided in the vehicular drive system 84 constructed as described above may be placed in the slipping state due to an abrupt increase of the drive torque transmitted from the engine 14 to the front wheels 20, which abrupt increase takes place as a result of the slipping action of at least one of the left and right rear wheels 30 on the low-.mu. roadway surface 76 during the straight running of the vehicle in the 4WD mode. As a result of the slipping action of the control clutch 12, the rotating speed of the side gear 16l on the side of the control clutch 12 becomes higher than the rotating speed of the side gear 16r on the side remote from the control clutch 12 so that the torque TF_{R} transmitted to the right front wheel 20r connected to the side gear 16r being rotated at the lower speed becomes larger than the torque TF_{L} transmitted to the left front wheel 20l, due to a friction resistance of the side gears 16l, 16r disposed within the front differential gear device 16, as indicated in FIG. 8. However, the braking force B applied to the right front wheel 20r by the hydraulic braking device 32 reduces the torque TF_{R} to be transmitted to the right front wheel 20r. In FIG. 8, the thus reduced torque value T_{R} is represented by TF_{R}'. Accordingly, the difference between the torques transmitted to the left and right front wheels 20l, 20r, that is, the difference between the torques TF_{L} and TF_{R}′ is adequately reduced.

The electronic control device provided for the vehicular drive system 84 serves as a control apparatus for a 4-wheel-drive vehicular drive system including the front differential gear device 16 driving the left and right front wheels 20l and 20r with the drive torque generated by the engine 14, and the rear differential gear device 26 for driving the left and right rear wheels 30l and 30r with the drive torque generated by the engine 14, and the 4-wheel-drive vehicular drive system is placed in the 4-wheel-drive mode when the control clutch 12 is placed in the engaged state. The cooperative control portion 74 of the electronic control device serves as the torque control portion configured to operate the hydraulic braking device 32 for reducing the torque TF_{R} to be transmitted to the right front wheel 20r, in the event of a slipping action of at least one of the left and right rear wheels 30l and 30r while the 4-wheel-drive vehicular drive system is placed in the 4-wheel-drive mode. The operation of the hydraulic braking device 32 to reduce the torque TF_{R} to be transmitted to the right front wheel 20r ensures a high degree of stability of straight running of the vehicle, even in the event of a slipping action of the control clutch 12 due to an abrupt increase of the drive torque TF_{R} received by the front differential gear device 16, which abrupt increase takes place due to a slipping action of at least one of the left and right rear wheels 30l and 30r and would cause the torque TF_{R} of the right front wheel 20r to be larger than the torque TF_{L} of the left front wheel 20l disposed on the side of the control clutch 12. Accordingly, the torque control portion reduces or prevents a risk of an unexpected counter-clockwise or clockwise rotary motion of the steering wheel 44 of the 4-wheel-drive vehicle during the straight running of the vehicle.

While the preferred embodiments of the present invention have been described in detail by reference to the drawings, it is to be understood that the invention may be otherwise embodied.

Although the vehicular drive system 10 is the 4-wheel-drive drive system which is placed in the 4-wheel-drive mode when the control clutch 12 is placed in the engaged state, the present invention is also applicable to a 2-wheel-drive system not provided with the front differential gear device 16.

In the illustrated embodiments, the front wheel slipping determining portion 68 of the electronic control devices 40, 78 for the vehicular drive system 10 makes the determination as to whether the front wheels 20l, 20r are placed in the slipping state, on the basis of the slip ratio Rs calculated on the basis of the output signals of the wheel speed sensors 46, 48, 50 and 52. However, the determination of the slipping state of the front wheels 20l and 20r may be made on the basis of the output signals of the load sensors 54, 56, 58 and 60.

The control clutch 12 may be of any one of hydraulic, electromagnetic and magnetic powder types, as long as the torque capacity of the control clutch 12 is controllable by the electronic control device 40, 78.

While the engine 14 is used as the drive power source in the vehicular drive system 10 in the illustrated embodiments, the drive power source may include an electric motor or electric motors.

It is to be understood that the foregoing embodiments and modifications have described for illustrative purpose only, and that the present invention may be embodied with various other changes and improvements which may occur to those skilled in the art.

### REFERENCE SIGNS LIST

10: vehicular drive system (4-wheel-drive vehicular drive system)
12: control clutch
14: engine (drive power source)
16: front differential gear device (front wheel drive device)
20l, 20r: front wheels
26: rear differential gear device (rear wheel drive device)
28l, 28r: rear axles (drive shafts)
30l, 30r: rear wheels (drive wheels)
32: hydraulic braking devices (braking device)
40, 78: electronic control device (control apparatus)
B: braking forces (braking torques)
T_{R}: torque
Ts: control clutch transmitted torque

1. A control apparatus for a vehicular drive system including a pair of drive shafts, a differential gear device for distributing a received drive torque to left and right drive wheels through said respective drive shafts, a control clutch associated with one of said drive shafts and configured to switch between its engaged and released states, and a braking device disposed to apply a braking force to one of said drive wheels which is disposed to the other of said drive shafts, said control apparatus comprising:
a torque control portion configured to operate said braking device for reducing the torque to be transmitted to said one of the drive wheels, in the event of an abrupt increase of the torque received by said differential gear device while said control clutch is placed in said engaged state.

2. The control apparatus according to claim 1, further comprising a braking force calculating portion configured to calculate a braking force which is generated by said braking device and applied to said one of said left and right drive wheels, such that the braking force reduces a difference between the torques to be transmitted to the left and right drive wheels, and wherein said torque control portion controls said braking device such that the calculated braking force is applied to said one of the drive wheels.

3. The control apparatus according to claim 1, wherein said torque control portion operates said braking device to output a braking torque on the basis of a control clutch transmitted torque which is transmitted through said control clutch, and according to a predetermined relationship between said braking force and said control clutch transmitted torque.

4. A control apparatus for a 4-wheel-drive vehicular drive system including a vehicular drive system as defined in claim 1 as a rear wheel drive device for driving said left and right drive wheels provided as left and right rear wheels, with a drive torque generated by a drive power source, and a front wheel drive device for driving left and right front wheels with the drive torque generated by said drive power source, said 4-wheel-drive vehicular drive system being placed in a 4-wheel-drive mode when said control clutch provided in said rear wheel drive device is placed in the engaged state, said control apparatus comprising:
a torque control portion configured to operate said braking device for reducing the torque to be transmitted to one of said left and right rear wheels which corresponds to said one of said left and right drive wheels, in the event of a slipping action of at least one of said left and right front wheels while said 4-wheel-drive vehicular drive system is placed in said 4-wheel-drive mode.

5. A control apparatus for a 4-wheel-drive vehicular drive system including a vehicular drive system as defined in claim 1 as a front wheel drive device for driving said left and right drive wheels provided as left and right front wheels, with a drive torque generated by a drive power source, and a rear wheel drive device for driving left and right rear wheels with the drive torque generated by said drive power source, said 4-wheel-drive vehicular drive system being placed in a 4-wheel-drive mode when said control clutch provided in said rear wheel drive device is placed in the engaged state, said control apparatus comprising:
a torque control portion configured to operate said braking device for reducing the torque to be transmitted to one of said left and right front wheels which corresponds to said one of said left and right drive wheels, in the event of a slipping action of at least one of said left and right rear wheels while said 4-wheel-drive vehicular drive system is placed in said 4-wheel-drive mode.
